(19) United States
(12) Patent Application Publication
(10) Pub. No.: US 2018/0150066 A1
(43) Pub. Date: May 31, 2018

(54) SCHEDULING SYSTEM AND METHOD

(71) Applicant: INSTITUTE FOR INFORMATION INDUSTRY, Taipei (TW)

(72) Inventors: Cheng-Hui CHEN, Nantou County (TW); Hung-An KAO, Taipei City (TW); Hung-Sheng CHIU, Taipei City (TW); Hsiao-Chen CHANG, Taipei City (TW)

(21) Appl. No.: 15/371,170

(22) Filed: Dec. 6, 2016

(30) Foreign Application Priority Data
Nov. 28, 2016 (TW) 105139098

(51) Int. Cl. G05B 19/418

(52) U.S. Cl. CPC G05B 19/41865; G05B 2219/24018; G05B 2219/25419

(57) ABSTRACT

The present disclosure provides a scheduling system and method. This method includes steps as follow. A communication device is connected to a plurality processing stations and receives instant process data of each processing station, where the instant process data includes a main program number and a processing time. According to target yield, delivery time and the instant process data of the processing stations, production line scheduling is calculated, and an estimated production is forecasted. It is determined that whether the actual production of the production line scheduling matches the estimated production. When the actual production is lower than the estimated production, based on the instant process data, a bottleneck station is determined from the processing stations. The machine diagnosis is performed on the bottleneck station to identify an abnormal cause.

### RELATED APPLICATIONS

This application claims priority to Taiwanese Application Ser. No. 105139098, filed Nov. 28, 2016, which is herein incorporated by reference.

### BACKGROUND

### Field of Invention

The present invention relates to computer systems and methods. More particularly, the present invention relates to scheduling systems and methods.

### Description of Related Art

Capacity planning is to provide a method to determine the size of the overall capacity that is integrated by capital-intensive resources, such as equipment, tools, facilities, and overall labor force size.

In the past, capacity planning was mostly a static model, and production planning and scheduling could be carried out by setting up manufacturing and other related data through production of the scheduling system. However, due to lack of the bottleneck station analysis, the production process of the whole product must consist of multiple process equipment to produce a series of manufacturing, if a process equipment has abnormalities, the output of defective semi-finished products or reduced production efficiency occurs, and then the follow-up several processes are affected, and finally yield and production are reduced.

In addition, the conventional scheduling system or method is often to improve production, stable delivery as the goal. But, for the different factories and production processes, the scheduling objectives are not the same. Therefore, aforesaid system or method cannot meet the requirement of most of the factories.

### SUMMARY

The following presents a simplified summary of the disclosure in order to provide a basic understanding to the reader. This summary is not an extensive overview of the disclosure and it does not identify key/critical components of the present invention or delineate the scope of the present invention. its sole purpose is to present some concepts disclosed herein in a simplified form as a prelude to the more detailed description that is presented later.

According to embodiments of the present disclosure, the present disclosure provides scheduling system and method, to solve or circumvent aforesaid problems and disadvantages.

In one embodiment, A scheduling system, comprises: a communication device communicated with a plurality of processing stations and configured to receive instant process data comprising a main program number and a processing time from each of the processing stations; a scheduling module configured to calculate a production line schedule and an estimated production according to a target yield, a delivery time and instant process data of the processing stations, wherein the target yield and the delivery time are preset in the scheduling module; and a diagnostic module configured to determine whether an actual production of the production line schedule matches the estimated production, to determine a bottleneck station from the processing stations according to the instant process data when the actual production is lower than the estimated production, and to perform a machine diagnosis on the bottleneck station, so as to identify an abnormal cause.

In one embodiment, the instant process data further comprises at least one of a spindle speed, a plurality of processing parameters, a yield, a cutting distance, a motor vibration frequency, a motor temperature and a machine oil pressure of each of the processing stations.

In one embodiment, the communication device further receives cutting tool data of a manufacturing execution system corresponding to the processing stations and personnel data of an enterprise resource planning system, and the scheduling module further calculate the production line schedule and the estimated production according to the cutting tool data and the personnel data.

In one embodiment, when the diagnostic module performs the machine diagnosis on the bottleneck station, it receives an actual measured value corresponding to the instant process data from at least one sensor of each of the processing stations through the communication device, so as to analyze and determine whether the bottleneck station is abnormal.

In one embodiment, the diagnostic module further sets parameter abnormal interval data for the instant process data of each of the processing stations, and compares actual measurement data corresponding to the instant process data with the parameter abnormal interval data for diagnosis.

In one embodiment, the parameter abnormal interval data comprises a threshold interval of machine production time, a threshold interval of machine abnormal parameters, a threshold interval of cutting tool abrasion length, a threshold interval of loading and unloading time and an threshold interval of operating time threshold interval.

In one embodiment, when the actual production of the production line schedule does not match the estimated production, the diagnostic module selects one having lowest production from the processing stations, analyzes and determines a plurality of abnormal diagnostic rates according to the parameter abnormal interval data of the bottleneck station, and weighting the abnormal diagnostic rates respectively to calculate an overall abnormal rate according to the target yield, the delivery time and the instant process data; when the overall abnormal rate is higher than a threshold value,, the diagnostic module readjusts the production line schedule to replace the bottleneck station.

In one embodiment, the scheduling module calculates the estimated production based on the processing time of the instant process data.

In one embodiment, the scheduling module calculates the production line schedule further according to at least one of a delivery rate, an utilization rate, a preset production and inventory data.

In one embodiment, a scheduling method implemented by a processor device, the processor device comprising a communication device, and the scheduling method comprising steps of: (A) using the communication device communicated with a plurality of processing stations and configured to receive instant process data comprising a main program number and a processing time from each of the processing stations; (B) using the processor device to calculate a production line schedule and an estimated production according to a target yield, a delivery time and instant process data of the processing stations, wherein the target yield and the delivery time are preset in the processor device; (C) using the processor device to determine whether an actual production of the production line schedule matches the estimated production, to determine a bottleneck station from the processing stations according to the instant process data when the actual production is lower than the estimated production; and (D) using the processor device to perform a machine diagnosis on the bottleneck station, so as to identify an abnormal cause.

In one embodiment, the instant process data further comprises at least one of a spindle speed, a plurality of processing parameters, a yield, a cutting distance, a motor vibration frequency, a motor temperature and a machine oil pressure of each of the processing stations.

In one embodiment, the step (A) comprises: using the communication device further receives cutting tool data of a manufacturing execution system corresponding to the processing stations and personnel data of an enterprise resource planning system, and the scheduling module further calculate the production line schedule and the estimated production according to the cutting tool data and the personnel data.

In one embodiment, the step (C) comprises: when the machine diagnosis is performed on the bottleneck station, receiving an actual measured value corresponding to the instant process data from at least one sensor of each of the processing stations through the communication device, so as to analyze and determine whether the bottleneck station is abnormal.

In one embodiment, the step (C) further comprises: setting parameter abnormal interval data for the instant process data of each of the processing stations, and comparing actual measurement data corresponding to the instant process data with the parameter abnormal interval data for diagnosis.

In one embodiment, the parameter abnormal interval data comprises a threshold interval of machine production time, a threshold interval of machine abnormal parameters, a threshold interval of cutting tool abrasion length, a threshold interval of loading and unloading time and an threshold interval of operating time threshold interval.

In one embodiment, the step (C) further comprises: when the actual production of the production line schedule does not match the estimated production, selecting one having lowest production from the processing stations, and the step (D) comprises: analyzing and determining a plurality of abnormal diagnostic rates according to the parameter abnormal interval data of the bottleneck station; weighting the abnormal diagnostic rates respectively to calculate an overall abnormal rate according to the target yield, the delivery time and the instant process data; and when the overall abnormal rate is higher than a threshold value, readjusting the production line schedule to replace the bottleneck station.

In one embodiment, the step (B) comprises: calculating the estimated production based on the processing time of the instant process data.

In one embodiment, the step (B) further comprises: calculating the production line schedule further according to at least one of a delivery rate, an utilization rate, a preset production and inventory data.

In view of the foregoing, the present disclosure provides bottleneck station analysis to calculate the whole abnormal rate. If there are other identical functional devices that can replace the bottleneck station, the scheduling decision selects the same equipment as the processing station. Otherwise, the scheduling decision informs the related personnel to make the correction and improvement on the bottleneck station (e.g., notify the maintenance staff to check the machine state), so as to enhance the overall scheduling efficiency.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of a scheduling system according to one embodiment of the present disclosure;

FIG. 2 is a flow chart of a scheduling method according to one embodiment of the present disclosure; and

FIGS. 3 and 4 are schematic diagrams of a production line schedule according to one embodiment of the present disclosure.

### DETAILED DESCRIPTION

In the following detailed description, for purposes of explanation, numerous specific details are set forth in order to attain a thorough understanding of the disclosed embodiments, In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one of the word modified by the article “a” or “the.”

Through the present specification and the annexed claims, the description involving the “electrical connection” refers to the cases where one component is electrically connected to another component indirectly via other component(s), or one component is electrically connected to another component directly without any other component.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

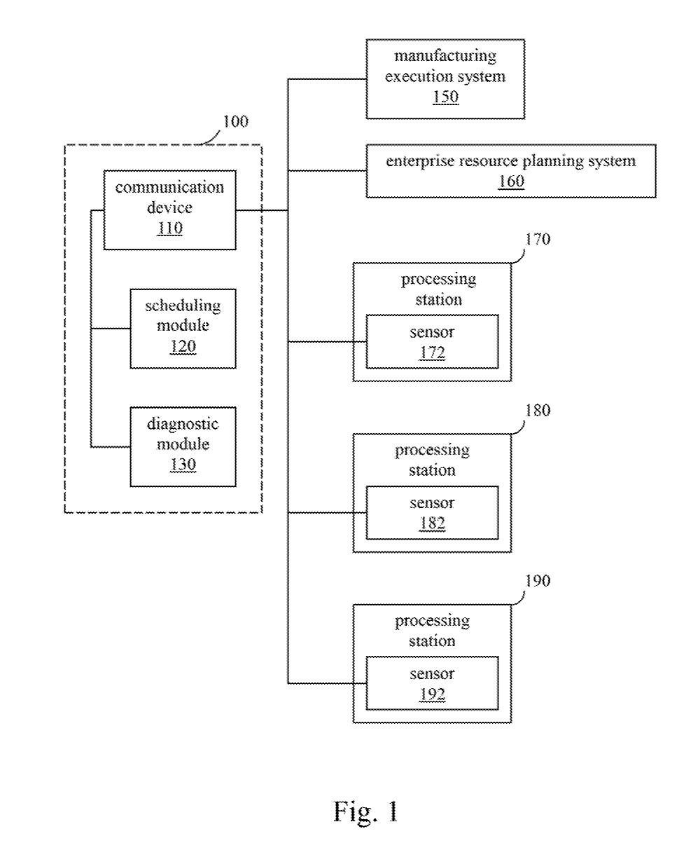

FIG. 1 is a block diagram of a scheduling system 100 according to one embodiment of the present disclosure. As illustrated in FIG. 1, the scheduling system 100 comprises a communication device 110, a scheduling module 120 and a diagnostic module 130. The scheduling module 120 and the diagnostic module 130 are electrically connected to the communication device 110, and the communication device 110 is communicated with a plurality of processing stations 170, 180 and 190.

In practice, the scheduling system 100 may be a processor device, such as a computer, a computing machine, a server, an embedded system, or other computing device. The communication device 110 may be a wired or wireless network card to communicate other devices (e.g., processing stations 170, 180 and 190) via a wired or wireless communication network (e.g., transmission lines). The scheduling module 120 and the diagnostic module 130 may be implemented as a processor, logic circuit, or other hardware architectures for executing software program. The processing stations 170, 180 and 190 may be a process machine, a tool, or other equipment.

The communication device is configured to receive instant process data comprising a main program number and a processing time from each of the processing, stations 170, 180 and 190. For example, the scheduling system 100 may provide a user interface for an administrator to set the target yield and the delivery time, or through the network the communication device 110 receives the target yield and the delivery time set by the administrator. Then, the scheduling system 100 presets the target yield and the delivery time in the scheduling module 120 for scheduling. The scheduling module 120 is configured to calculate a production line schedule and an estimated production according to the target yield, the delivery time and instant process data of the processing stations. The diagnostic module 130 is configured to determine whether an actual production of the production line schedule matches the estimated production, to determine a bottleneck station from the processing stations according to the instant process data when the actual production is lower than the estimated production, and to perform a machine diagnosis on the bottleneck station (e.g., the processing station 180), so as to identify an abnormal cause. Moreover, the scheduling module 120 provides modification of the instant process data of the bottleneck station 180, so as to adjust operation of the bottleneck station 180 in responsive to the abnormal cause, but the present disclosure is not limited thereto.

In one embodiment, the instant process data further comprises at least one of a spindle speed, a plurality of processing parameters, a yield, a cutting distance, a motor vibration frequency, a motor temperature and a machine oil pressure of each of the processing stations.

In one embodiment, the communication device 110 further receives cutting tool data (e.g., a cutting tool type, a cutting tool abrasion length and so on) of a manufacturing execution system (MES) 150 (e.g., a server or other computer) corresponding to the processing stations 170, 180 and 190 (e.g., lathes, milling machines and machining centers or other cutting process machines) and personnel data of an enterprise resource planning (ERP) system 160 (e.g., Digiwin Tiptop, Workflow, Oracle R series, SAP ERP, a server or other computer). The personnel data includes information on personnel who can participate in the scheduling, seniority, the contact time for the machine or other relevant information. The scheduling module 120 further calculates the production line schedule and the estimated production according to the cutting tool data and the personnel data. For example, the scheduling module 120 evaluates a cutting efficiency according to the cutting tool type and the cutting tool abrasion length, evaluates a personnel operational efficiency according to the information on the personnel who can participate in the scheduling, the seniority and the contact time for the machine, and calculate the estimated production based on the cutting efficiency and the personnel operational efficiency. In practice, the scheduling system 100 can convert the communication formats of the different systems 150 and 160 through the inter-system communication format knowledge base to output the unified format process information to the scheduling module 120.

In one embodiment, when the diagnostic module 130 performs the machine diagnosis on the bottleneck station 180, it receives an actual measured value corresponding to the instant process data from at least one sensor 172, 182 and 192 (e.g., a temperature sensor, a pressure sensor, an acceleration gauge, a displacement gauge, an oil pressure gauge, or other sensing element) of each of the processing stations 170, 180 and 190 through the communication device 110, so as to analyze and determine whether the bottleneck station 180 is abnormal.

As to determination of abnormality, in one embodiment, the diagnostic module 130 further sets parameter abnormal interval data for the instant process data of each of the processing stations 170, 180 and 190, and compares actual measurement data corresponding to the instant process data with the parameter abnormal interval data for diagnosis. For example, if the actual measurement data is related to the parameter abnormal interval data, the diagnostic module 130 determines the bottleneck station 180 is abnormal; if the actual measurement data and the parameter abnormal interval data are not matched, the diagnostic module 130 determines the bottleneck station 180 is in normal operation, but the present disclosure is not limited thereto.

Specifically, in one embodiment, the parameter abnormal interval data comprises a threshold interval of machine production time, a threshold interval of machine abnormal parameters, a threshold interval of cutting tool abrasion length, a threshold interval of loading and unloading time and an threshold interval of operating time threshold interval. Thus, the scheduling module 120 can continue to calculate and further update the operation information (e.g., a processing time, a production, an utilization rate, etc) of each station through the instant process data. The processing time and the production can be obtained from controllers of the processing stations 170, 180 and 190. The processing time divided by the operating time of the processing station equals the utilization rate. At the same time, the upper and lower thresholds are continuously defined and corrected according to the curve of the accumulated parameters.

In one embodiment, when the actual production of the production line schedule does not match the estimated production, the diagnostic module 130 selects one as the bottleneck station 180 from the processing stations, in which the selected one has lowest production or a largest difference exists between a current production of the selected one and the estimated production. The diagnostic module 130 analyzes and determines a plurality of abnormal diagnostic rates, such as an abnormal rate of loading and unloading time, an abnormal rate of operating time, an abnormal rate of machine production time, an abnormal rate of machine parameters an abnormal rate of cutting tool abrasion length and so on, according to the parameter abnormal interval data of the bottleneck station 180. The diagnostic module 130 weights the abnormal diagnostic rates respectively to calculate an overall abnormal rate according to the target yield, the delivery time and the instant process data. In one specific embodiment, the diagnostic module 130 weights the abnormal rates of the loading and unloading time, the operating time, the machine production time, the cutting tool abrasion and the machine parameters (e.g., a vibration signal, and a temperature signal) over thresholds to calculate an overall abnormal rate. When the overall abnormal rate is higher than a threshold value, the diagnostic module 120 readjusts the production line schedule to replace the bottleneck station 180. In practice, there may have multiple parallel machines that can replace the processing station. For example, three idle machines are capable of performing an edge-cutting process, and therefore except that one originally serves as a predetermined processing station, the other two can also serves as the processing station for performing the edge-cutting process. Moreover, an additional machine may be also added in the processing station. Furthermore, the diagnostic module 130 informs the relevant equipment or process personnel for adjusting abnormal parameters, the process is back to normal.

For example, the overall abnormal rate=the abnormal time of the production of the personnel×the abnormal rate of the target utilization+the abnormal time of the production of the machine×the abnormal rate of the target utilization+the abnormal value of the machine parameters×the abnormal rate of the target equipment+the abnormal value of the cutting tool abrasion x the abnormal rate of the target equipment. For example, the target setting indicates that the utilization rate has a highest priority, in which the abnormal rate of the target utilization is 80%. Therefore, if the production time threshold is calculated to be 15 minutes, and the personnel production time is 20 minutes that is over this threshold and is called as the abnormal time of the production of the personnel. The abnormal time rate of the production of the personnel is 20115=1.33, and the abnormal rate of the target utilization is 0.8, so that the abnormal time rate of the production of the personnel (1.33)×the target abnormal ratio (0.8)=1.064, and so on. The abnormal rate of the target utilization is a time-dependent anomaly, which refers to the weighting of the target, so that when the target setting indicates that the utilization rate has a highest priority, the abnormal rate of the target utilization is higher. And, time is most relevant to the utilization rate, and therefore all abnormalities as to time need to be weighted in order to enlarge the abnormal parameters according to the target. The abnormal rate of the target equipment is the equipment-related anomaly, and the equipment is biased towards the possibility of machine failure. Therefore, the abnormal rate of the target equipment is related to the abnormal value of the machine parameter and the abnormal value of the cutting tool abrasion, and then weighting is performed thereon, as described above.

In one embodiment, the scheduling module 120 calculates the estimated production based on the processing time of the instant process data. For example, the scheduling module 120 is based on the processing time and the current production of the instant process data to calculate production per unit time for the processing stations 170, 180 and 190, so as to calculates the estimated production in the delivery time, but the present disclosure is not limited thereto.

In one embodiment, the scheduling module 120 calculates the production line schedule further according to at least one of a delivery rate, the utilization rate, a preset production and inventory data.

In one embodiment, when the actual production of the production line schedule does not match the estimated production, the diagnostic module 130 selects one as the bottleneck station 180 from the processing stations 170, 180 and 190, in which the selected one has lowest production or a largest difference exists between a current production of the selected one (e.g. equipment) and the estimated production. Then, the bottleneck station analysis is performed on the processing station 180. If the processing station 180 is not the bottleneck station, the bottleneck station analysis is performed on the next station (e.g., the processing station 170). Finally, all of processing stations 170, 180 and 190 are analyzed.

In view of the foregoing, the scheduling system 100 analyzes the bottleneck station and calculates the whole abnormal rate through the bottleneck station analysis. If there are other identical functional devices that can replace the bottleneck station 180, the scheduling decision of the scheduling system 100 selects the same equipment as the processing station 180. Otherwise, the scheduling decision informs the related personnel to make the correction and improvement on the bottleneck station (e.g. notify the maintenance staff to check the machine state), so as to enhance the overall scheduling efficiency.

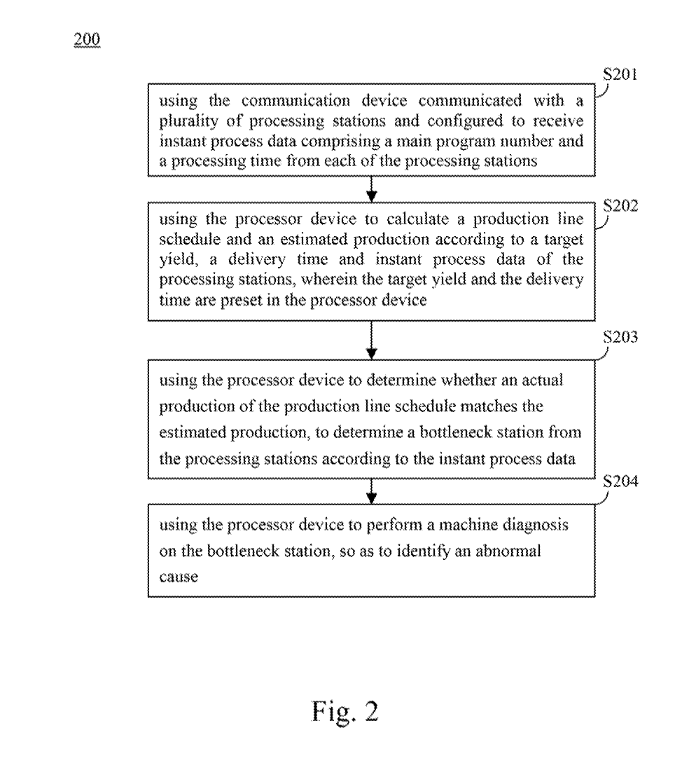

For a more complete understanding of a scheduling method 200 performed by the scheduling system 100, refer to FIG. 2. FIG. 2 is a flow chart of the scheduling method 200 according to one embodiment of the present disclosure. In practice, the processor device e.g., the scheduling system 100), comprising the communication device 100, implements scheduling method 200. As illustrated in FIG. 2, the scheduling method 200 includes the operations S201-S204. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. With reference to FIGS. 1-2, some embodiments are explanted below.

In operation S201, the communication device is used to receive instant process data comprising a main program number and a processing time from each of the processing stations 170, 180 and 190 (e.g., lathes, milling machines and machining centers or other cutting process machines).

In operation S202, the processor device is used to calculate a production line schedule and an estimated production according to a target yield, a delivery time and instant process data of the processing stations, wherein the target yield and the delivery time are preset in the processor device.

In operation S203, the processor device is used to determine whether an actual production of the production line schedule matches the estimated production, to determine a bottleneck station 180 from the processing stations 170, 180 and 190 according to the instant process data when the actual production is lower than the estimated production. Then, in operation S204, the processor device is used to perform a machine diagnosis on the bottleneck station 180, so as to identify an abnormal cause. Moreover, in operation S204, the processor device provides modification of the instant process data of the bottleneck station 180, so as to adjust operation of the bottleneck station 180 in responsive to the abnormal cause, but the present disclosure is not limited thereto.

In the scheduling method 200, the instant process data further comprises at least one of a spindle speed, a plurality of processing parameters, a yield, a cutting distance, a motor vibration frequency, a motor temperature and a machine oil pressure of each of the processing stations.

In the scheduling method 200, the operation S201 comprises a step of using the communication device 110 further receives cutting tool data (e.g., a cutting tool type, a cutting tool abrasion length and so on) of a manufacturing execution system 150 corresponding to the processing stations 170, 180 and 190 and personnel data (e.g., information on personnel who can participate in the scheduling, seniority, the contact time for the machine or other relevant information) of an enterprise resource planning system 160, and further calculating the production line schedule and the estimated production according to the cutting tool data and the personnel data. For example, the operation S201 comprises: evaluating a cutting efficiency according to the cutting tool type and the cutting tool abrasion length, evaluating a personnel operational efficiency according to the information on the personnel who can participate in the scheduling, the seniority and the contact time for the machine, and calculating the estimated production based on the cutting efficiency and the personnel operational efficiency.

In the scheduling method 200, the operation S203 comprises a step of performing the machine diagnosis on the bottleneck station 180, and receiving an actual measured value corresponding to the instant process data from at least one sensor 172, 182 and 192 (e.g., a temperature sensor, a pressure sensor, an acceleration gauge, a displacement gauge, an oil pressure gauge, or other sensing element) of each of the processing stations 170, 180 and 190 through the communication device 110, so as to analyze and determine whether the bottleneck station 180 is abnormal.

In the scheduling method 200, the operation S203 further comprises a step of setting parameter abnormal interval data for the instant process data of each of the processing stations 170, 180 and 190, and compares actual measurement data corresponding to the instant process data with the parameter abnormal interval data for diagnosis.

In the scheduling method 200, the parameter abnormal interval data comprises a threshold interval of machine production time, a threshold interval of machine abnormal parameters, a threshold interval of cutting tool abrasion length, a threshold interval of loading and unloading time and an threshold interval of operating time threshold interval.

In the scheduling method 200, in the operation S203 comprises a step of selecting one as the bottleneck station 180 from the processing stations when the actual production of the production line schedule does not match the estimated production, in which the selected one has lowest production or a largest difference exists between a current production of the selected one and the estimated production. Then, the operation S204 comprises steps of analyzing and determining a plurality of abnormal diagnostic rates according to the parameter abnormal interval data of the bottleneck station 180; and weighting the abnormal diagnostic rates respectively to calculate an overall abnormal rate according to the target yield, the delivery time and the instant process data. In one specific embodiment, the abnormal rates of the loading and unloading time, the operating time, the machine production time, the cutting tool abrasion and the machine parameters (e.g., a vibration signal, and a temperature signal) over thresholds are weighted to calculate the overall abnormal rate. When the overall abnormal rate is higher than a threshold value, the production line schedule is readjusted to replace the bottleneck station 180. In practice, there may have multiple parallel machines that can replace the processing station. For example, three idle machines are capable of performing an edge-cutting process,and therefore except that one originally serves as a predetermined processing station, the other two can also serves as the processing station for performing the edge-cutting process. Moreover, an additional machine may be also added in the processing station. Furthermore, the diagnostic module 130 informs the relevant equipment or process personnel for adjusting abnormal parameters, the process is back to normal.

In the scheduling method 200, in the operation S203 comprises a step of calculating the estimated production based on the processing time of the instant process data. For example, the operation S203 is based on the processing time and the current production of the instant process data to calculate production per unit time for the processing stations 170, 180 and 190, so as to calculates the estimated production in the delivery time, but the present disclosure is not limited thereto.

In the scheduling method 200, in the operation S202 comprises a step of calculating the production line schedule further according to at least one of a delivery rate, the utilization rate, a preset production and inventory data.

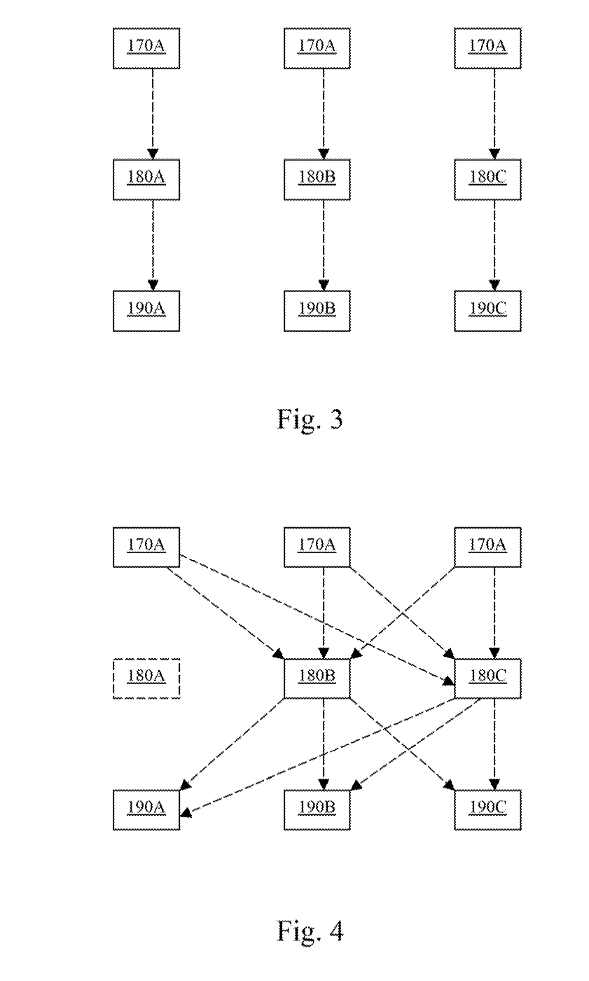

For a more complete understanding of the scheduling method 200, refer to FIGS. 3 and 4. FIGS. 3 and 4 are schematic diagrams of a production line schedule according to one embodiment of the present disclosure. With reference to FIGS. 1-4, some embodiments are explanted below.

In FIG. 3, the production line schedule is carried out in operation S202. The first batch of work-pieces is processed through processing stations 170A, 180A and 190A, and the second batch of work-pieces is processed through the processing station 170B, 180B and 190B, and the third batch of the work-pieces is processed through the processing station 170C, 180C and 190C. The processing station 170A, 170B and 170C are the same type of parallel processing station, but their use of time, brand, old and new styles may be different. The processing station 180A, 180B and 180C are the same type of parallel processing station, but their use of time, brand, old and new styles may be different. The processing station 190A, 190B and 190C are the same type of parallel processing station, but their use of time, brand, old and new styles may be different.

In FIG. 4, if the processing station 180A is diagnosed as the bottleneck station, and the production line schedule is readjusted in operation S203. For example, the work-pieces that have been processed by the processing stations 170A, 180A and 190A are selectively processed through the processing stations 180B and 180C, and then are processed through the processing stations 190A, 190B and 190C respectively. In this way, the schedule method 200 can avoid the bottleneck station 180A, thereby informing the personnel for the problem correction (e.g., maintenance of the machine) of the bottleneck station 180A or the replacement of the bottleneck station 180A, so as to decrease the probability of reduction in the delivery rate.

In view of the foregoing, the present disclosure provides bottleneck station analysis to calculate the whole abnormal rate. If there are other identical functional devices that can replace the bottleneck station, the scheduling decision selects the same equipment as the processing station. Otherwise, the scheduling decision informs the related personnel to make the correction and improvement on the bottleneck station (e.g., notify the maintenance staff to check the machine state), so as to enhance the overall scheduling efficiency.

Methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus (e.g., module) for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus (e.g., module) for practicing the disclosed methods. When implemented on a general-purpose processor, the program code combines with the processor to provide a unique apparatus that operates analogously to application specific logic circuits.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A scheduling system, comprising:
a communication device communicated with a plurality of processing stations and configured to receive instant process data comprising a main program number and a processing time from each of the processing stations;
a scheduling module configured to calculate a production line schedule and an estimated production according to a target yield, a delivery time and instant process data of the processing stations, wherein the target yield and the delivery time are preset in the scheduling module; and
a diagnostic module configured to determine whether an actual production of the production line schedule matches the estimated production, to determine a bottleneck station from the processing stations according to the instant process data when the actual production is lower than the estimated production, and to perform a machine diagnosis on the bottleneck station, so as to identify an abnormal cause.

2. The scheduling system of claim 1, wherein the instant process data further comprises at least one of a spindle speed, a plurality of processing parameters, a yield, a cutting distance, a motor vibration frequency, a motor temperature and a machine oil pressure of each of the processing stations.

3. The scheduling system of claim 2, wherein the communication device further receives cutting tool data of a manufacturing execution system (MES) corresponding to the processing stations and personnel data of an enterprise resource planning (ERP) system, and the scheduling module further calculate the production line schedule and the estimated production according to the cutting tool data and the personnel data.

4. The scheduling system of claim 2, wherein when the diagnostic module performs the machine diagnosis on the bottleneck station, it receives an actual measured value corresponding to the instant process data from at least one sensor of each of the processing stations through the communication device, so as to analyze and determine whether the bottleneck station is abnormal.

5. The scheduling system of claim 4, wherein the diagnostic module further sets parameter abnormal interval data for the instant process data of each of the processing stations, and compares actual measurement data corresponding to the instant process data with the parameter abnormal interval data for diagnosis.

6. The scheduling system of claim 5, wherein the parameter abnormal interval data comprises a threshold interval of machine production time, a threshold interval of machine abnormal parameters, a threshold interval of cutting tool abrasion length, a threshold interval of loading and unloading time and an threshold interval of operating time threshold interval.

7. The scheduling system of claim 5, wherein when the actual production of the production line schedule does not match the estimated production, the diagnostic module selects one having lowest production as the bottleneck station from the processing stations, analyzes and determines a plurality of abnormal diagnostic rates according to the parameter abnormal interval data of the bottleneck station, and weighting the abnormal diagnostic rates respectively to calculate an overall abnormal rate according to the target yield, the delivery time and the instant process data; when the overall abnormal rate is higher than a threshold value, the diagnostic module readjusts the production line schedule to replace the bottleneck station.

8. The scheduling system of claim 1, wherein the scheduling module calculates the estimated production based on the processing time of the instant process data.

9. The scheduling system of claim 8, wherein the scheduling module calculates the production line schedule further according to at least one of a delivery rate, an utilization rate, a preset production and inventory data.

10. A scheduling method implemented by a processor device, the processor device comprising a communication device, and the scheduling method comprising steps of:
(A) using the communication device communicated with a plurality of processing stations and configured to receive instant process data comprising a main program number and a processing time from each of the processing stations;
(B) using the processor device to calculate a production line schedule and an estimated production according to a target yield, a delivery time and instant process data of the processing stations, wherein the target yield and the delivery time are preset in the processor device;
(C) using the processor device to determine whether an actual production of the production line schedule matches the estimated production, to determine a bottleneck station from the processing stations according to the instant process data when the actual production is lower than the estimated production; and
(D) using the processor device to perform a machine diagnosis on the bottleneck station, so as to identify an abnormal cause.

11. The scheduling method of claim 10, wherein the instant process data further comprises at least one of a spindle speed, a plurality of processing parameters, a yield, a cutting distance, a motor vibration frequency, a motor temperature and a machine oil pressure of each of the processing stations.

12. The scheduling method of claim 11, wherein the step (A) comprises:
using the communication device further receives cutting tool data of a manufacturing execution system corresponding to the processing stations and personnel data of an enterprise resource planning system, and the scheduling module further calculate the production line schedule and the estimated production according to the cutting tool data and the personnel data.

13. The scheduling method of claim 11, wherein the step (C) comprises:
when the machine diagnosis is performed on the bottleneck station, receiving an actual measured value corresponding to the instant process data from at least one sensor of each of the processing stations through the communication device, so as to analyze and determine whether the bottleneck station is abnormal.

14. The scheduling method of claim 13, wherein the step (C) further comprises:
setting parameter abnormal interval data for the instant process data of each of the processing stations, and comparing actual measurement data corresponding to the instant process data with the parameter abnormal interval data for diagnosis.

15. The scheduling method of claim 14, wherein the parameter abnormal interval data comprises a threshold interval of machine production time, a threshold interval of machine abnormal parameters, a threshold interval of cutting tool abrasion length, a threshold interval of loading and unloading time and an threshold interval of operating time threshold interval.

16. The scheduling method of claim 14, wherein the step (C) further comprises: when the actual production of the production line schedule does not match the estimated production, selecting one having lowest production as the bottleneck station from the processing stations, and the step (D) comprises:
analyzing and determining a plurality of abnormal diagnostic rates according to the parameter abnormal interval data of the bottleneck station;
weighting the abnormal diagnostic rates respectively to calculate an overall abnormal rate according to the target yield, the delivery time and the instant process data; and
when the overall abnormal rate is higher than a threshold value, readjusting the production line schedule to replace the bottleneck station.

17. The scheduling method of claim 10, wherein the step (B) comprises:
calculating the estimated production based on the processing time of the instant process data.

18. The scheduling method of claim 17, wherein the step (B) further comprises:
calculating the production line schedule further according to at least one of a delivery rate, an utilization rate, a preset production and inventory data.
